(19) United States
(12) Patent Application Publication
(10) Pub. No.: US 2009/0033762 A1
(43) Pub. Date: Feb. 5, 2009

(54) Color photographing apparatus

(75) Inventor: Tetsuya Abe, Tokyo (JP)

Correspondence Address: OLIFF & BERRIDGE, PLC, P.O. BOX 320850, ALEXANDRIA, VA, 22320-4850, US

(73) Assignee: NIKON CORPORATION, Tokyo (JP)

(21) Appl. No.: 12/219,038

(22) Filed: Jul. 15, 2008

(30) Foreign Application Priority Data
Aug. 3, 2007 (JP) 2007-202819

(51) Int. Cl. H04N 9/873; G03B 7/00

(52) U.S. Cl. 348/223.1; 396/225; 348/E05.031

(57) ABSTRACT

A proposition is to provide a color photographing apparatus capable of reducing the failure probability of white balance adjusting. For this purpose, the color photographing apparatus includes a discriminating unit calculating an accuracy of a shooting scene belonging to a specific group having a similar illumination color based on a feature vector of the shooting scene and a discriminant criterion preliminarily calculated by supervised learning, and a calculating unit calculating an adjusting value of the white balance adjusting to be performed on an image shot in the shooting scene based on the calculated accuracy and the image.

### CROSS-REFERENCE TO RELATED APPLICATION

This application is based upon and claims the benefit of priority from Japanese Patent Application No. 2007-20281 9, filed on Aug. 3, 2007, the entire contents of which are incorporated herein by reference.

### BACKGROUND

1. Field

The present invention relates to a color photographing apparatus incorporating a white balance adjusting function.

2. Description of the Related Art

Patent document 1 discloses a method for discriminating a kind of illumination used for shooting an image, for calculating an adjusting value of white balance adjusting to be performed on the image. This method calculates preliminarily a discriminant criterion by supervised learning making a specific color component (e.g., R component) of the image to be a feature value, and discriminates whether or not the kind of illumination used for shooting is a specific kind of illumination, based on the discriminant criterion and the feature value extracted from each image (Patent document 1: Japanese Unexamined Patent Application Publication No. 2006-129442).

However, since the discrimination for the image having a delicate color is difficult when multiple kinds of illumination are used for the shooting, or the like, there is a high probability that a false discrimination occurs and the white balance adjusting fails.

### SUMMARY

Accordingly, a proposition of the present invention is to provide a color photographing apparatus capable of reducing the failure probability of the white balance adjusting.

For this purpose, a color photographing apparatus of the present invention includes a discriminating unit calculating an accuracy of a shooting scene belonging to a specific group having a similar illumination color, based on a feature vector of the shooting scene and a discriminant criterion calculated preliminarily by supervised learning, and a calculating unit calculating an adjusting value of white balance adjusting to be performed on an image shot in the shooting scene based on the calculated accuracy and the image.

Note that the discriminating unit preferably calculates the Euclidean distance between the feature vector and the discriminant criterion in a vector space as an index for the accuracy.

Further, the discriminating unit may calculate the accuracy for each of a plurality of specific groups having different illumination colors.

Still further, the calculating unit calculates the adjusting value based on a frequency of each color existing in the image and may perform weighting for the frequency of the each color according to the accuracy calculated for each of the plurality of specific groups.

Yet still further, the calculating unit may determine a weight value to be provided to the frequency of the each color according to the accuracy calculated for each of the plurality of specific groups and a similarity degree between the illumination color of the specific group and the each color.

Yet still further, the calculating unit may emphasize, among the plurality of specific groups, the accuracy calculated for a specific group which is easy to discriminate from other groups than the accuracy calculated for a specific group which is difficult to discriminate from other groups.

Yet still further, the plurality of specific groups may be any three among a group having the illumination color which would belong to a chromaticity range of a low-color-temperature illumination, a group having the illumination color which would belong to the chromaticity range of a fluorescent lamp or a mercury lamp, a group having the illumination color which would belong to the chromaticity range of a fluorescent lamp with good color rendering properties or natural sunlight, and a group having the illumination color which would belong to the chromaticity range of a shadow area or cloudy weather.

Yet still further, the discriminating unit preferably performs the calculation of the accuracy during a period before shooting and the calculating unit preferably performs the calculation of the adjusting value immediately after shooting.

Yet still further, the discriminating unit is preferably a support vector machine.

Yet still further, any of the color photographing apparatus of the present invention may additionally include an adjusting unit performing the white balance adjusting on the image using the adjusting value calculated by the calculating unit.

### BRIEF DESCRIPTION OF THE DRAWINGS

FIG. 1 is a schematic diagram showing a configuration of an optical system in an electronic camera.

FIG. 2 is a block diagram showing a circuit configuration of the electronic camera.

FIG. 3 is a diagram showing an achromatic detection range in a first embodiment.

FIG. 4 is a diagram showing a distribution example of learning samples in a vector space.

FIG. 5 is a diagram showing a relationship (one example) between a distance d₁ and the number of samples.

FIG. 6 is a diagram showing a relationship (one example) between a distance d₂ and the number of samples.

FIG. 7 is a diagram showing a relationship (one example) between a distance d₃ and the number of samples.

FIG. 8 is an operational flowchart of a CPU 29 in the first embodiment regarding shooting.

FIG. 9 is an operational flowchart of the CPU 29 in a second embodiment regarding shooting.

FIG. 10 is a diagram showing a relationship between a weight coefficient W_{D1} and the distance d₁.

FIG. 11 is a diagram showing a relationship between a weight coefficient W_{D2} and the distance d₂.

FIG. 12 is a diagram showing a relationship between a weight coefficient W_{D3} and the distance d₃.

FIG. 13 is a diagram showing a magnitude correlation of a coefficient K.

### DETAILED DESCRIPTION OF THE EMBODIMENTS

### First Embodiment

The present embodiment is an embodiment for an electronic camera. Here, the electronic camera is assumed to be a monocular reflex type.

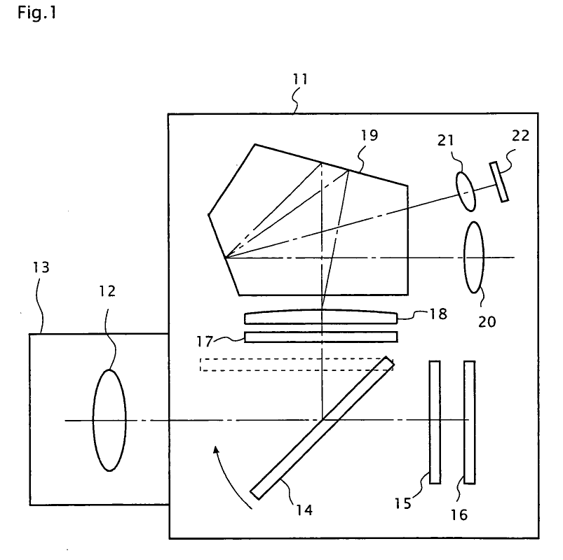

First, a shooting mechanism of the electronic camera will be described. FIG. 1 is a schematic diagram showing a configuration of an optical system in the electronic camera. As shown in FIG. 1, the electronic camera includes a camera body 11, and a lens unit 13 containing a shooting lens 12. The lens unit 13 is interchangeably attached to the camera body 11 via a not-shown mount.

A main mirror 14, a mechanical shutter 15, a color image sensor 16 and a viewfinder optical system (17 to 20) are disposed in the camera body 11. The main mirror 14, the mechanical shutter 15, and the color image sensor 16 are disposed along the optical axis of the shooting lens 12, and the viewfinder optical system (17 to 20) is disposed in the upper region of the camera body 11.

The main mirror 14 rotates around a not-shown rotation axis and thereby is switched between an observing mode and a disembarrassing mode. The main mirror 14 in the observing mode is disposed obliquely in front of the mechanical shutter 15 and the color image sensor 16. This main mirror 14 in the observing mode reflects a light flux captured by the shooting lens 12 upward and guides the light flux to the viewfinder optical system (17 to 20). Note that the center part of the main mirror 14 has a half mirror and a part of the light flux transmitted through the main mirror 14 in the observing mode is guided to a not-shown focus detecting unit by a sub-mirror.

Meanwhile, the main mirror 14 is flipped upward in the disembarrassing mode and disposed in a position apart from a shooting optical path. When the main mirror 14 is in the disembarrassing mode, the light flux captured by the shooting lens 12 is guided to the mechanical shutter 15 and the color image sensor 16.

The viewfinder optical system (17 to 20) includes a focusing glass 17, a condensing lens 18, a pentagonal prism 19, and an eyepiece lens 20. A re-image forming lens 21 and a divided photometric sensor 22 are disposed in the neighborhood of the pentagonal prism 19 thereamong.

The focusing glass 17 is located above the main mirror 14. The light flux focused on this focusing glass 17 enters an incident plane at the bottom of the pentagonal prism 19 via the condensing lens 18. A part of the light flux having entered the incident plane, after reflected by inner surfaces of the pentagonal prism 19, is output from an exit plane perpendicular to the incident plane to the outside of the pentagonal prism 19 and is directed toward the eyepiece lens 20.

Further, another part of the other light flux having entered the incident plane, after reflected by the inner surfaces of the pentagonal prism 19, is output from the exit plane to the outside of the pentagonal prism 19 and is guided to the divided photometric sensor 22 via the re-image forming lens 21.

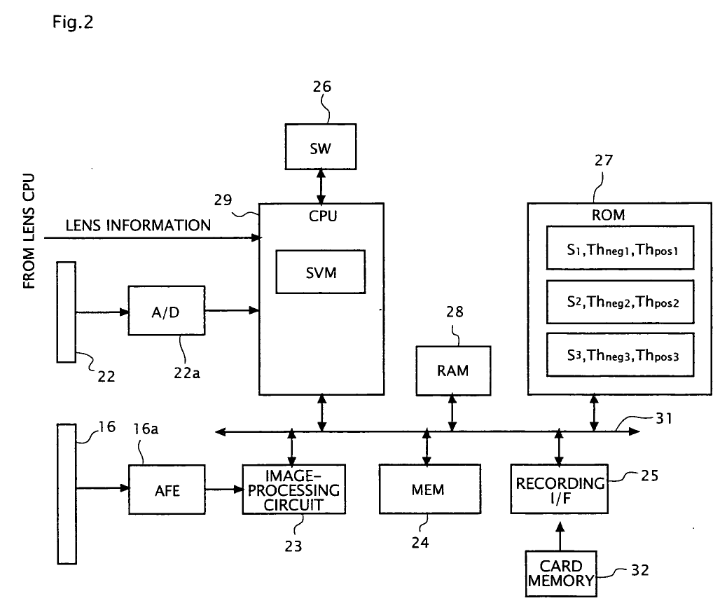

Next, a circuit configuration of the electronic camera will be described. FIG. 2 is a block diagram showing the circuit configuration of the electronic camera. As shown in FIG. 2, the camera body 11 includes the color image sensor 16, an AFE 16a, the divided photometric sensor 22, an A/D-converting circuit 22a, an image-processing circuit 23, a buffer memory (MEM) 24, a recording interface (recording I/F) 25, an operating switch (SW) 26, a CPU 29, a RAM 28, a ROM 27, and a bus 31. Among these components, the image-processing circuit 23, buffer memory 24, recording interface 25, CPU 29, RAM 28, and ROM 27 are coupled with each other via the bus 31. Further, the operating switch 26 is coupled to the CPU 29.

The color image sensor 16 is a color image sensor provided for generating an image for recording (main image). The color image sensor 16 generates an analog image signal of the main image by performing photoelectric conversion on a field image formed on an imaging plane thereof. Note that, on the imaging plane of the color image sensor 16, three kinds of color filters, red (R), green (G), and blue (B), are disposed in the Bayer arrangement, for example, for detecting colors of the field image. Thereby, the analog image signal of the main image is made up of three components, an R component, a G component, and a B component.

The AFE 16a is an analog front end circuit performing signal processing on the analog image signal generated by the color image sensor 16. This AFE 16a performs correlated double sampling of the image signal, gain adjustment of the image signal, and A/D conversion of the image signal. The image signal (digital image signal) output from this AFE 16a is input into the image-processing circuit 23 as image data of the main image.

The divided photometric sensor 22 is a color image sensor provided for monitoring chromaticity distribution and luminance distribution of a field in a non-shooting mode. On the imaging plane of the divided photometric sensor 22, a field image is formed to have the same range as that of the field image formed on the imaging plane of the color image sensor 16. The divided photometric sensor 22 generates an analog image signal of the field image by performing photoelectric conversion on the field image formed on the imaging plane thereof. Note that color filters are disposed on the imaging plane of the divided photometric sensor 22 for detecting the colors of the field image. Thereby, an image signal of this field image is also made up of the three components, the R component, the G component, and the B component. Note that the analog image signal of the field image output from this divided photometric sensor 22 is input into the CPU 29 via the A/D-converting circuit 22a.

The image-processing circuit 23 performs various kinds of image processing (color interpolation processing, gradation conversion processing, contour emphasis processing, white balance adjusting, etc.) on the image data of the main image input from the AFE 16a. Parameters in each of the various kinds of processing (gradation conversion characteristic, contour emphasis strength, white balance adjusting value, etc.) are calculated appropriately by the CPU 29. Among these parameters, the white balance adjusting value includes an R/G-gain value and B/G-gain value.

The buffer memory 24 stores temporarily the image data of the main image at a required timing during operation of the image-processing circuit 23 for compensating processing speed differences among the various kinds of processing in the image-processing circuit 23.

The recording interface 25 is provided with a connector for coupling a recording medium 32 with each other. The recording interface 25 accesses the recording medium 32 coupled to the connector and performs write-in and read-out of the image data of the main image. Note that the recording medium 32 is configured by a hard disk or a memory card containing a semiconductor memory.

The operating switch 26 is configured with a release button, a command dial, a cross-shaped cursor key, etc. and provides a signal to the CPU 29 according to operation contents by a user. For example, the user provides a shooting instruction to the CPU 29 by fully pressing the release button. Further, the user provides an instruction to the CPU 29 for switching recording modes by manipulating the operating switch 26.

Note that there are a normal-recording mode and a RAW-recording mode for the recording modes, and the normal-recording mode is a recording mode in which the CPU 29 records the image data of the main image after the image processing into the recording medium 32 and the RAW-recording mode is a recording mode in which the CPU 29 records the image data of the main image (RAW-data) before the image processing into the recording medium 32.

The CPU 29 is a processor controlling the electronic camera collectively. The CPU 29 reads out a sequence program preliminarily stored in the ROM 27 to the RAM 28, and calculates parameters of the individual processing or controls each part of the electronic camera by executing the program. At this time, the CPU 29 acquires lens information, if necessary, from a not-shown lens CPU in the lens unit 13. This lens information includes information such as the focal distance, the subject distance, and the f-number of the shooting lens 12.

Further, the CPU 29 functions as a support vector machine (SVM) performing calculation of an accuracy that a present shooting scene belongs to a specific group D₁ (first discrimination), by executing the program. In addition, this SVM can also perform calculation of an accuracy that the present shooting scene belongs to another group D₂ (second discrimination) and calculation of an accuracy that the present shooting scene belongs to a group D₃ (third discrimination).

Here, the group D₁, group D₂, or group D₃ is an individual group formed by grouping various shooting scenes by illumination colors thereof. Further, respective discriminant criteria of the first discrimination, the second discrimination, and the third discrimination in the SVM are calculated preliminarily by supervised learning of the SVM. These discriminant criteria are stored preliminarily in the ROM 27 as data of discriminant planes S₁, S₂, and S₃.

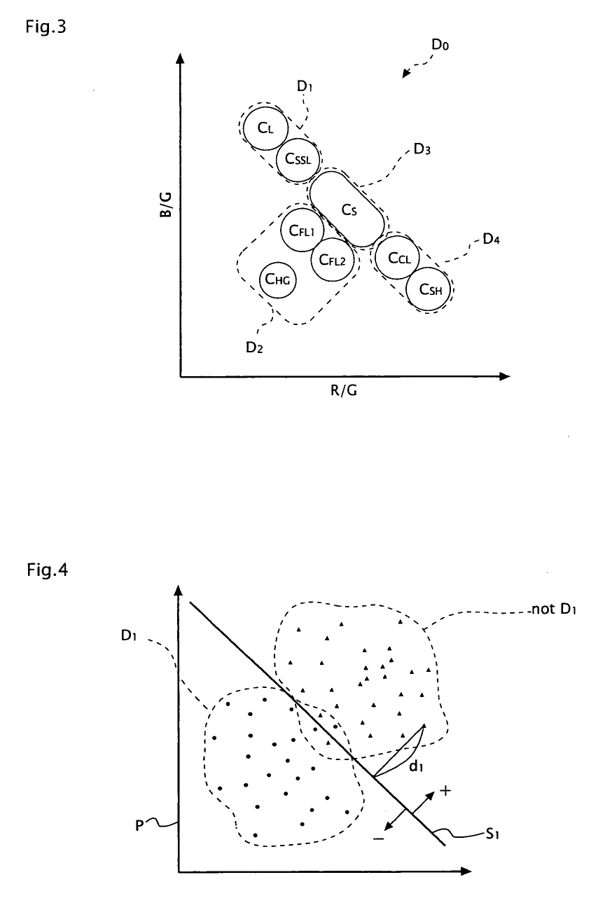

Next, each of the groups will be described in detail. FIG. 3 shows a diagram expressing various achromatic detection ranges on chromaticity coordinates. The data of these achromatic detection ranges is preliminarily stored in the ROM 27. These achromatic detection ranges are made up of achromatic ranges distributed in the neighborhood of a blackbody radiation locus, C_{L}, C_{SSL}, C_{FL1}, C_{FL2}, C_{HG}, C_{S}, C_{CL}, and C_{SH}, described below.

Achromatic detection range C_{L}: Chromaticity range of an electrical light bulb (=Chromaticity range of an achromatic object illuminated by an electrical light bulb)

Achromatic detection range C_{SSL}: Chromaticity range of sunset (=Chromaticity range of an achromatic object illuminated by sunset light)

Achromatic detection range C_{FL1}: Chromaticity range of a first fluorescent lamp (=Chromaticity range of an achromatic object illuminated by a first fluorescent lamp)

Achromatic detection range C_{FL2}: Chromaticity range of a second fluorescent lamp (=Chromaticity range of an achromatic object illuminated by a second fluorescent lamp)

Achromatic detection range C_{HG}: Chromaticity range of a mercury lamp (=Chromaticity range of an achromatic object illuminated by a mercury lamp)

Achromatic detection range C_{S}: Chromaticity range of clear weather (=Chromaticity range of an achromatic object existing in clear weather)

Note that the chromaticity of a fluorescent lamp having good color rendering properties belongs to this chromaticity range.

Achromatic detection range C_{CL}: Chromaticity range of cloudy weather (=Chromaticity range of an achromatic object existing in cloudy weather)

Achromatic detection range C_{SH}: Chromaticity range of a shadow area (=Chromaticity range of an achromatic object existing in a shadow area)

Then, the groups D₁, D₂, and D₃ are defined as follows.

Group D₁: Group of shooting scenes where the illumination colors would belong to either of the achromatic detection ranges C_{L} and C_{SSL} having a comparatively low color temperature

Group D₂: Group of shooting scenes where the illumination colors would belong to any of the achromatic detection ranges C_{FL1}, C_{FL2}, and C_{HG}

Group D₃: Group of shooting scenes where the illumination colors would belong to the achromatic detection range C_{S}

Further, Groups D₄ and D₀ are defined as follows.

Group D₄: Group of shooting scenes where the illumination colors would belong to either of the achromatic detection ranges C_{CL} and C_{SH}

Group D₀: Group of shooting scenes where the illumination colors would belong to any of the achromatic detection ranges C_{L}, C_{SSL}, C_{FL1}, C_{FL2}, C_{HG}, C_{S}, C_{CL}, and C_{SH}

Next, contents of the supervised learning for calculating the discriminant planes S₁, S₂, and S₃ will be described.

Learning samples used in this learning are a number of shooting scenes expected for the electronic camera, and have labeling indicating to which group the samples belongs among the group D₁, group D₂, group D₃, and group D₄.

From each of the learning samples, there is extracted a 15-dimensional feature vector having vector components x₁, x₂, . . . , x₁₅. Each of the vector components is made of the following values.

x₁=Mean Bᵥ-value of a field

x₂=Maximum Bᵥ-value of the field

x₃=Minimum Bᵥ-value of the field

x₄=Standard deviation of Bᵥ-value of the field

x₅=Mean B/G-value of the field

x₆=Maximum B/G-value of the field

x₇=Minimum B/G-value of the field

x₈=Standard deviation of B/G-value of the field

x₉=Mean R/G-value of the field

x₁₀=Maximum R/G-value of the field

x₁₁=Minimum R/G-value of the field

x₁₂=Standard deviation of R/G-value of the field

x₁₃=Edge amount existing in the field

x₁₄=Focal distance of a shooting lens

x₁₅=Subject distance of the shooting lens

Among these vector components, the vector components x₁ to x₁₃ are calculated based on the image signal generated by the divided photometric sensor 22. Meanwhile, the vector components x₁₄ and x₁₅ are determined by the lens information acquired from the lens CPU. Further, the vector component x₁₃ is calculated as follows.

First, the G component of the image signal generated by the divided photometric sensor 22 is subjected to edge filter processing in the X direction and edge filter processing in the Y direction. Thereby, the edge amount in the X direction and the edge amount in the Y direction are calculated for the field. Then, a sum of the edge amount in the X direction and the edge amount in the Y direction is calculated. The sum becomes the vector component x₁₃.

In the learning, the feature vectors of all the learning samples are expressed as points in a vector space. Among these feature vectors, the feature vector of each learning sample belonging to the group D₁ and the feature vector of each learning sample not belonging to the group D₁ have different distribution regions as shown by dotted lines in FIG. 4. Here in FIG. 4, the 15-dimensional vector space P is expressed as a two-dimensional space for simplicity.

Next, a hyper plane is calculated such that margins between the learning samples belonging to the group D₁ and the learning samples not belonging to the group D₁ are maximized, and the hyper plane is determined to be a discriminant plane S₁. The data of this discriminant plane S₁ is written into the ROM 27.

Here, the Euclidean distance d₁ from the discriminant plane S₁ to each of the learning samples is considered as shown in FIG. 4. Note that the polarity of the distance d₁ is determined to be positive for a side where many of the learning samples not belonging to the group D₁ are distributed and is determined to be negative for a side where many of the learning samples belonging to the group D₁ are distributed.

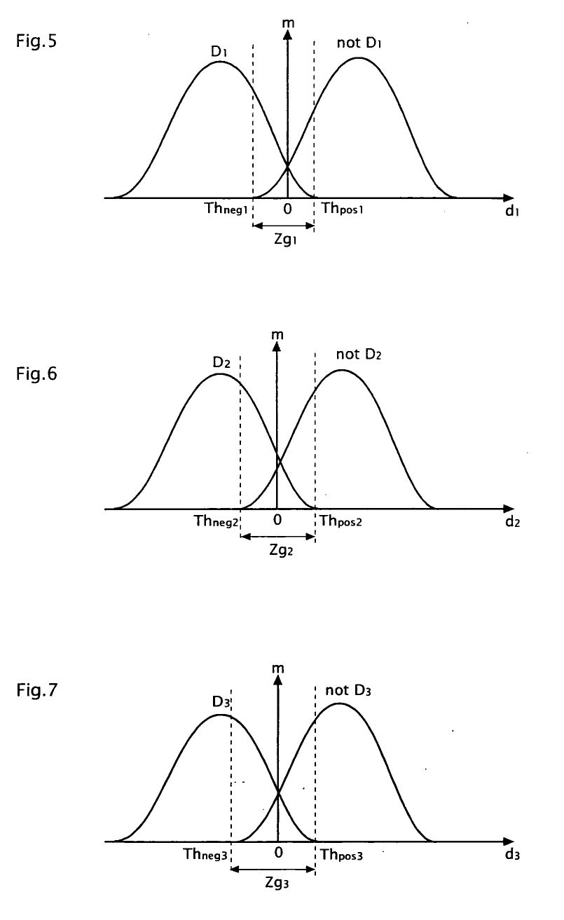

FIG. 5 is a diagram showing a relationship between this distance d₁ and the number of samples m. As shown in FIG. 5, while the distances d₁ become negative for many of the learning samples belonging to the group D₁ and the distances d₁ become positive for many of the learning samples not belonging to the group D₁, there are learning samples which have positive distances d₁ even though belonging to the group D₁ and the learning samples which have negative distances d₁ even though not belonging to the group d₁. Here, a range Zg₁ for the distance d₁ of such a learning sample is called “gray area Zg₁”. If this gray area Zg₁ is narrower, discriminant capability of the first discrimination is assumed to be higher (that is, the group D₁ is easy to discriminate from other groups).

Accordingly, the present embodiment calculates a plus-side boundary value Thₚₒₛ₁, and a minus-side boundary value Th_{neg1} for this gray area Zg₁ when calculating the discriminant plane S₁. The data of these boundary values Thₚₒₛ₁ and Th_{neg1} is written into the ROM 27 together with the data of the discriminant plane S₁.

Next, a hyper plane is calculated in the vector space P such that the margins between the learning samples belonging to the group D₂ and the learning samples not belonging to the group D₂ are maximized, and the hyper plane is determined to be a discriminant plane S₂. Further, a gray area Zg₂ in the neighborhood of the discriminant plane S₂ is calculated, and a plus-side boundary value Thₚₒₛ₂ and a minus-side boundary value Th_{neg2} for the gray area Zg₂ are calculated (refer to FIG. 6). The data of these discriminant plane S₂, boundary values Thₚₒₛ₂ and Th_{neg2} is written into the ROM 27.

Note that the gray area Zg₂ shown in FIG. 6 is assumed to be larger than the gray area Zg₁ shown in FIG. 5. That is, the discriminant capability of the second discrimination is lower than that of the first discrimination (the group D₂ is more difficult to discriminate from the other group than the group D₁).

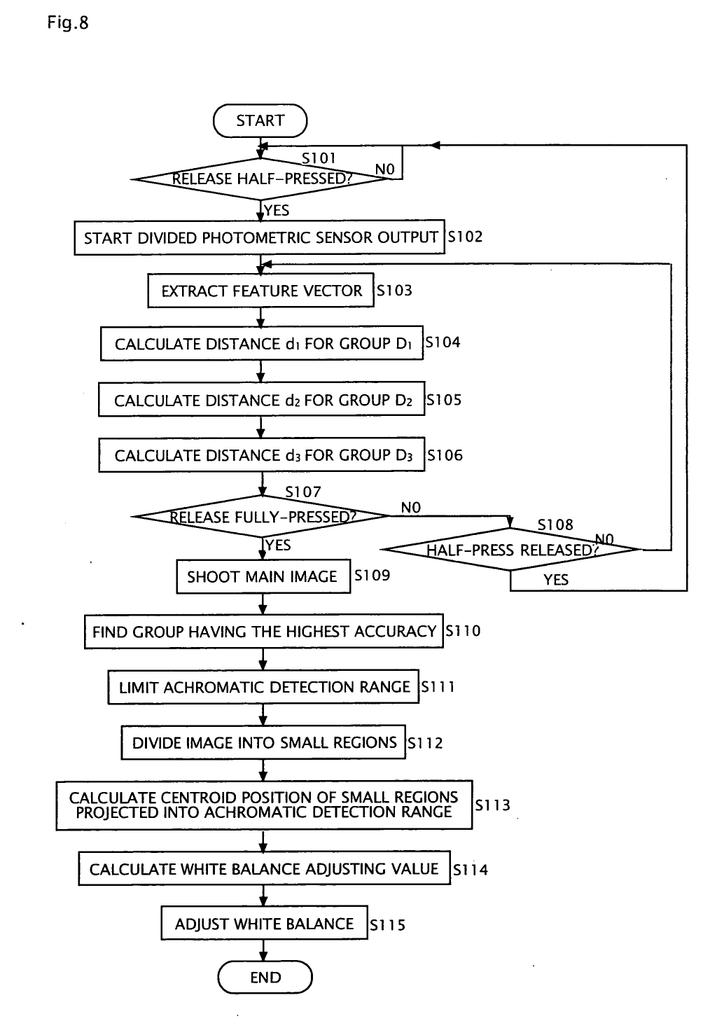

Next, a hyper plane is calculated in the vector space P such that the margins between the learning samples belonging to the group D₃ and the learning samples not belonging to the group D₃ are maximized, and the hyper plane is determined to be a discriminant plane S₃. Further, a gray area Zg₃ in the neighborhood of the discriminant plane S₃ is calculated, and a plus-side boundary value Thₚₒₛ₃ and a minus-side boundary value Th_{neg3} for the gray area Zg₃ are calculated (refer to FIG. 7). The data of these discriminant plane S₃, boundary values Thₚₒₛ₃ and Th_{neg3} is written into the ROM 27.

Note that the gray area Zg₃ shown in FIG. 7 is assumed to be larger than the gray area Zg₂ shown in FIG. 6. That is, the discriminant capability of the third discrimination is lower than that of the second discrimination (the group D₃ is more difficult to discriminate from the other group than the group D₂).

Next, an operational flow of the CPU 29 regarding shooting will be described. FIG. 8 is an operational flowchart of the CPU 29 regarding shooting. Here, it is assumed that an auto-white-balance function of the electronic camera is switched on and the recording mode of the electronic camera is set to the normal-recording mode. Further, it is assumed that the main mirror 14 is in the observing mode and a user can observe a field through the eyepiece lens 20 at the start point of the flowchart.

Step S101: The CPU 29 determines whether or not the release button has been half-pressed. If the release button has been half-pressed, the process goes to a step S102 and if the release button has not been half-pressed, the step 101 is repeated.

Step S102: The CPU 29 carries out focus adjustment of the shooting lens 12 and also causes the divided photometric sensor 22 to start outputting an image signal of a field. Note that the focus adjustment is performed by the CPU 29 providing a defocus signal generated by the focus detection unit to the lens CPU. At this time, the lens CPU changes a lens position of the shooting lens 12 so as to make the defocus signal provided by the CPU 29 close to zero, and thereby adjusts the focal point of the shooting lens 12 onto an object in the field (subject).

Step S103: The CPU 29 extracts the feature vector from the present shooting scene by the SVM function. This extraction is carried out based on the image signal of the field output from the divided photometric sensor 22 and the lens information (lens information after the focus adjustment) provided by the lens CPU. The feature vector is a feature vector having the same vector component as that of the feature vector extracted in the learning.

Step S104: The CPU 29 calculates the distance d₁ between the feature vector extracted in Step S103 and the discriminant plane S₁ by the SVM function (first discrimination). The smaller this distance d₁ is, the higher is the accuracy of the present shooting scene belonging to the group D₁, and the larger the distance d₁ is, the lower is the accuracy of the present shooting scene belonging to the group D₁.

Step S105: The CPU 29 calculates a distance d₂ between the feature vector extracted in Step S103 and the discriminant plane S₂ by the SVM function (second discrimination). The smaller this distance d₂ is, the higher is the accuracy of the present shooting scene belonging to the group D₂, and the larger the distance d₂ is, the lower is the accuracy of the present shooting scene belonging to the group D₂.

Step S106: The CPU 29 calculates a distance d₃ between the feature vector extracted in Step S103 and the discriminant plane S₃ by the SVM function (third discrimination). The smaller this distance d₃ is, the higher is the accuracy of the present shooting scene belonging to the group D₃, and the larger the distance d₃ is, the lower is the accuracy of the present shooting scene belonging to the group D₃.

Step S107: The CPU 29 determines whether or not the release button has been fully pressed. If the release button has not been fully pressed, the process goes to S108, and if the release button has been fully pressed, the process goes to S109.

Step S108: The CPU 29 determines whether or not the release button has been released from the half-pressed state. If the release button has been released from the half-pressed state, the CPU 29 interrupts the signal output of the divided photometric sensor 22 and the process returns to the step S101, and if the release button is continued to be half-pressed, the process returns to the step S103.

Step S109: The CPU 29 carries out shooting processing and acquires the image data of a main image. That is, the CPU 29 moves the main mirror 14 to a position for the disembarrassing mode and further acquires the image data of the main image by driving the color image sensor 16. The data of the main image passes through the AFE 16a and the image-processing circuit 23 in a pipeline method, and is retained into the buffer memory 24 for buffering. After the shooting processing, the main mirror 14 is returned to a position for the observing mode.

Step S110: The CPU 29 refers to the values of the distances d₁, d₂, and d₃ calculated in the steps S104, S105, and S106, and finds the smallest one thereof.

When the value of the distance d₁ is the smallest, the CPU 29 assumes that the present shooting scene belongs to the group D₁ and sets a group number i of the present shooting scene to be “1”. Note that, even though d₁ is the smallest, the CPU 29 assumes that the present shooting scene belongs to the group D₄ when Thₚₒₛ₁<d₁, and sets the group number i of the present shooting scene to be “4”. Further, when Th_{neg1}<d₁<Thₚₒₛ₁ (d₁ is positioned in the gray area Zg₁), the CPU 29 assumes that the present shooting scene belongs to the group D₀ and sets the group number i of the present shooting scene to be “0”.

When the distance d₂ is the smallest, the CPU 29 assumes that the present shooting scene belongs to the group D₂ and sets the group number i of the present shooting scene to be “2”. Note that, even though d₂ is the smallest, the CPU 29 assumes that the present shooting scene belongs to D₄ when Thₚₒₛ₂<d₂, and sets the group number i of the present shooting scene to be “4”. Further, when Th_{neg2}<d₂<Thₚₒₛ₂ (d₂ is positioned in the gray area Zg₂), the CPU 29 assumes that the present shooting scene belongs to the group D₀ and sets the group number i of the present shooting scene to be “0”.

When the distance d₃ is the smallest, the CPU 29 assumes that the present shooting scene belongs to the group D₃ and sets the group number i of the present shooting scene to be “3”. Note that, even though d₃ is the smallest, the CPU 29 assumes that the present shooting scene belongs to D₄ when Thₚₒₛ₃<d₃, and sets the group number i of the present shooting scene to be “4”. Further, when Th_{neg3}<d₃<Thₚₒₛ₃ (d₃ is positioned in the gray area Zg₃), the CPU 29 assumes that the present shooting scene belongs to the group D₀ and sets the group number i of the present shooting scene to be “0”.

Step S111: The CPU 29 limits the achromatic detection ranges defined on the chromaticity coordinates (FIG. 3) to the range corresponding to the group number i which is now being set. That is, when the group number i is “1”, the achromatic detection ranges other than the achromatic detection ranges C_{L} and C_{SSL} are made to be invalid, when the group number i is “2”, the achromatic detection ranges other than the achromatic detection ranges C_{FL1}, C_{FL2}, and C_{HG} are made to be invalid, when the group number i is “3”, the achromatic detection ranges other than the achromatic detection range C_{S} are made to be invalid, when the group number i is “4”, the achromatic detection ranges other than the achromatic detection ranges C_{CL} and C_{SH} are made to be invalid, and when the group number i is “0”, all the achromatic detection ranges are made to be valid.

Step S112: The CPU 29 divides the main image into a plurality of small regions.

Step S113: The CPU 29 calculates chromaticity of each small region of the main image (average chromaticity in the small region) and projects each of the small regions on to the chromaticity coordinates according to the chromaticity thereof. Further, the CPU 29 finds the small regions projected into the valid achromatic detection ranges among the small regions, and calculates a centroid position of these small regions on the chromaticity coordinates. Then, the CPU 29 assumes the chromaticity corresponding to the centroid position to be the illumination color used in the shooting.

Note that the calculation of the centroid position is preferably performed after the chromaticity of each small region has been converted into correlated color temperature. The correlated color temperature includes a color temperature component Tc, and a difference component duv from the blackbody radiation locus, and thereby makes the computation simple in averaging a plurality of chromaticity values (weighted average). Further, in the calculation of the centroid position, considering the luminance of each small region, the number (frequency) of the small regions having high luminance may be counted on the larger side.

Step S114: The CPU 29 calculates a white balance adjusting value from the correlated color temperature (Tc and duv) of the calculated centroid position. This white balance adjusting value is a white balance adjusting value for expressing a region, which has the same chromaticity as that of the correlated color temperature (Tc and duv) on the main image before white balance adjusting, in an achromatic color.

Step S115: The CPU 29 provides the calculated white balance adjusting value to the image-processing circuit 23 and also provides an image processing instruction to the image-processing circuit 23. The image-processing circuit 23 performs the white balance adjusting and other image processing on the image data of the main image according to the instruction. The image data of the main image after the image processing is recorded into the recording medium 32 by the CPU 29.

As described hereinabove, the CPU 29 of the present embodiment calculates an accuracy that a shooting scene belongs to a specific group based on the feature vector of the shooting scene and the discriminant criterion calculated preliminarily by the supervised learning, and estimates an illumination color in the shooting based on the accuracy and the main image.

That is, for estimating the illumination color in the shooting of the main image, the CPU 29 of the present embodiment does not utilize a rough discrimination result whether or not the shooting scene belongs to a specific group, but utilizes a detailed discrimination result of the accuracy that the shooting scene belongs to the specific group.

Therefore, the CPU 29 of the present embodiment can reduce the probability that the illumination color is falsely estimated in a shooting scene which is not sure to belong to the specific group. Accordingly, the failure probability of the white balance adjusting can be reduced.

Further, the CPU 29 of the present embodiment calculates the Euclidean distance in the vector space, between the feature vector of the shooting scene and the discriminant plane, as an index of the accuracy that the shooting scene belongs to the specific group, and thereby the accuracy can be detected correctly.

Still further, the CPU 29 of the present embodiment performs the calculation of the accuracy that the shooting scene belongs to the specific group in a time before shooting, and thereby it is possible to suppress a computation amount when estimating the illumination color immediately after the shooting.

Yet still further, the discrimination in the present embodiment is performed by the SVM, and thereby has a high discriminant capability for an unknown shooting scene and an advantage in versatility.

### Second Embodiment

The present embodiment is a variation of the first embodiment. Here, only a different point from the first embodiment will be described. The different point is in the operation of the CPU 29.

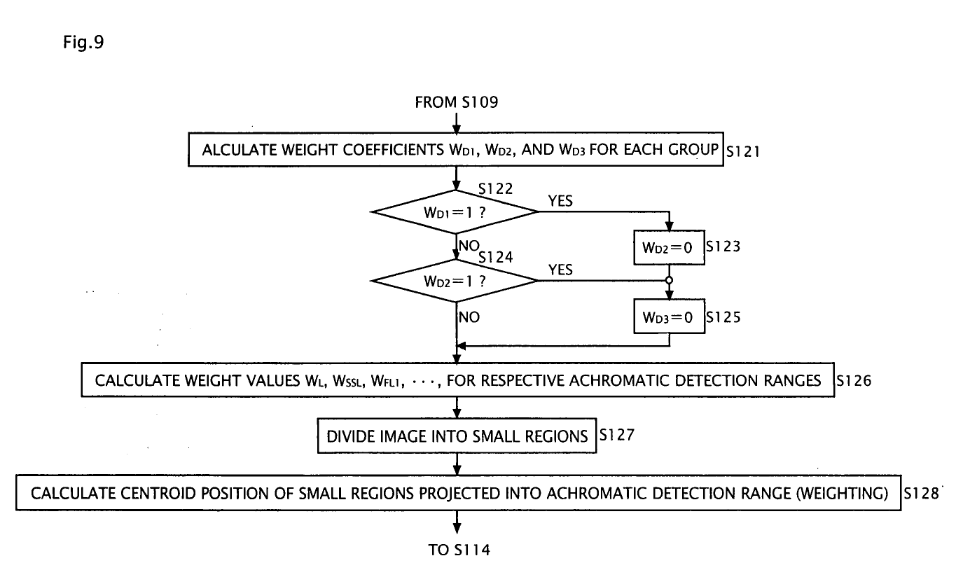

The CPU 29 of the present embodiment performs steps S121 to S128 in FIG. 9, instead of the steps S110 to S113 in FIG. 8.

Step S121: The CPU 29 refers to the distances d₁, d₂, and d₃ calculated in the above steps S104, S105 and S106, calculates a weight coefficient W_{D1} of the group D₁, based on the distance d₁, calculates a weight coefficient W_{D2} of the group D₂, based on the distance d₂, and calculates a weight coefficient W_{D3} of the group D₃, based on the distance d₃.

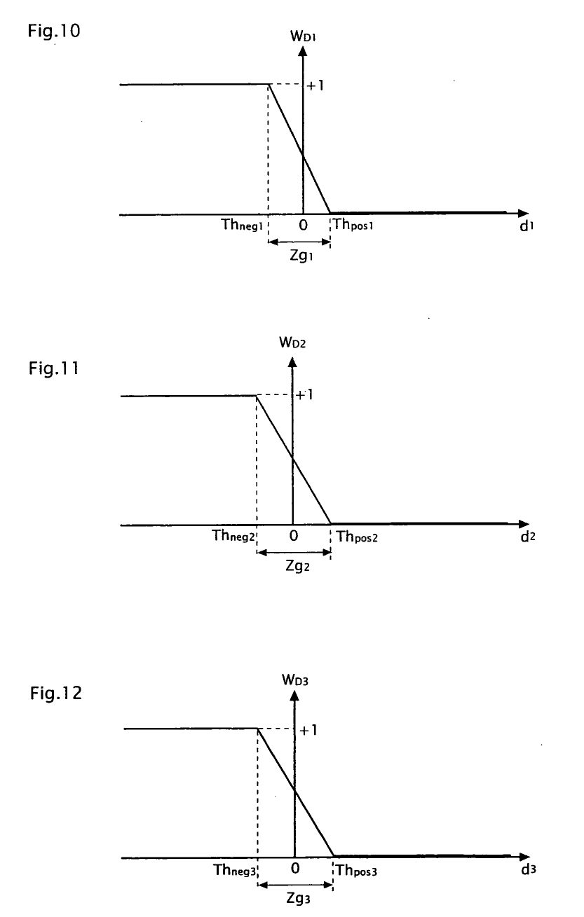

Here, a relationship between the weight coefficient W_{D1} calculated here and the distance d₁ is as shown in FIG. 10, a relationship between the weight coefficient W_{D2} and the distance d₂ is as shown in FIG. 11, and a relationship between the weight coefficient W_{D3} and the distance d₃ is as shown in FIG. 12. That is, the weight coefficient W_{Di} of a group Dᵢ is calculated from a distance dᵢ, boundary values Th_{negi} and Thₚₒₛᵢ of a gray area Zgᵢ by the following formula.

$${W}_{Di} = \{ \begin{matrix}1 & ( {d}_{i} < {Th}_{negi} ) \\ 1 - \frac{{d}_{i} - {Th}_{negi}}{{Th}_{posi} - {Th}_{negi}} & ( {Th}_{negi} < {d}_{i} < {Th}_{posi} ) \\ 0 & ( {Th}_{posi} < {d}_{i} )\end{matrix}$$

Step S122: The CPU 29 determines whether or not the value of the weight coefficient W_{D1} of the group D₁ is “1”. If the value is “1”, the process goes to a step S123, and if the value is not “1”, the process goes to a step S124.

Step S123: The CPU 29 replaces the value of the weight coefficient W_{D2} of the group D₂ by “0” and then the process goes to a step S125.

Step S124: The CPU 29 determines whether or not the value of the weight coefficient W_{D2} of the group D₂ is “1”. If the value is “1”, the process goes to the step S125, and if the value is not “1”, the process goes to a step S126.

Step S125: The CPU 29 replaces the value of the weight coefficient W_{D3} of the group D₃ by “0”, and then the process goes to the step S126.

Step S126: The CPU 29, based on the weight coefficients W_{D1}, W_{D2}, and W_{D3} at this point, calculates each of a weight value W_{L} for the achromatic detection range C_{L}, a weight value W_{SSL} for the achromatic detection range C_{SSL}, a weight value W_{FL1} for the achromatic detection range C_{FL1}, a weight value W_{FL2} for the achromatic detection range C_{FL2}, a weight value W_{HG} for the achromatic detection range C_{HG}, a weight value W_{S} for the achromatic detection range C_{S}, a weight value W_{CL} for the achromatic detection range C_{CL}, and a weight value W_{SH} for the achromatic detection range C_{SH}.

Here, a relationship of the weight value W_{L} of the achromatic detection range C_{L} to the weight coefficients W_{D1}, W_{D2}, and W_{D3} is as follows.

W_{L}=K(C_{L}, D₁)·W_{D1}+K(C_{L}, D₂)·W_{D2}+K(C_{L}, D₃)·W_{D3}+Of(C_{L})

where the coefficient K(C_{L}, Dᵢ) in the formula is a value determined by a similarity degree between the achromatic detection range C_{L} and the illumination color of a group Dᵢ, and the coefficient Of(C_{L}) is a predetermined offset value.

A relationship of the weight value W_{SSL} of the achromatic detection range C_{SSL} to the weight coefficients W_{D1}, W_{D2}, and W_{D3} is as follows.

W_{SSL}=K(C_{SSL}, D₁)·W_{D1}+K(C_{SSL}, D₂)·W_{D2}+K(C_{SSL}, D₃)·W_{D3}+Of(C_{SSL})

where the coefficient K(C_{SSL}, Dᵢ) in the formula is a value determined by the similarity degree between the achromatic detection range C_{SSL} and the illumination color of a group Dᵢ, and the coefficient Of(C_{SSL}) is a predetermined offset value.

A relationship of the weight value W_{FL1} of the achromatic detection range C_{FL1} to the weight coefficients W_{D1}, W_{D2}, and W_{D3} is as follows.

W_{FL1}=K(C_{FL1}, D₁)·W_{D1}+K(C_{FL1}, D₂)·W_{D2}+K(C_{FL1}, D₃)·W_{D3}+Of(C_{FL1})

where, the coefficient K(C_{FL1}, Dᵢ) in the formula is a value determined by the similarity degree between the achromatic detection range C_{FL1} and the illumination color of a group Dᵢ, and the coefficient Of(C_{FL1}) is a predetermined offset value.

A relationship of the weight value W_{FL2} of the achromatic detection range C_{FL2} to the weight coefficients W_{D1}, W_{D2}, and W_{D3} is as follows.

W_{FL2}=K(C_{FL2}, D₁)·W_{D1}+K(C_{FL2}, D₂)·W_{D2}+K(C_{FL2}, D₃)·W_{D3}+Of(C_{FL2})

where the coefficient K(C_{FL2}, Dᵢ) in the formula is a value determined by the similarity degree between the achromatic detection range C_{FL2} and the illumination color of a group Dᵢ, and the coefficient Of(C_{FL2}) is a predetermined offset value.

A relationship of the weight value W_{HG} of the achromatic detection range C_{HG} to the weight coefficients W_{D1}, W_{D2}, and W_{D3} is as follows.

W_{HG}=K(C_{HG}, D₁)·W_{D1}+K(C_{HG}, D₂)·W_{D2}+K(C_{HG}, D₃)·W_{D3}+Of(C_{HG})

where the coefficient K(C_{HG}, Dᵢ) in the formula is a value determined by the similarity degree between the achromatic detection range C_{HG} and the illumination color of a group Dᵢ, and the coefficient Of(C_{HG}) is a predetermined offset value.

A relationship of the weight value W_{S} of the achromatic detection range C_{S} to the weight coefficients W_{D1}, W_{D2}, and W_{D3} is as follows.

W_{S}=K(C_{S}, D₁)·W_{D1}+K(C_{S}, D₂)·W_{D2}+K(C_{S}, D₃)·W_{D3}+Of(C_{S})

where the coefficient K(C_{S}, Dᵢ) in the formula is a value determined by the similarity degree between the achromatic detection range C_{S} and the illumination color of a group Dᵢ, and the coefficient Of(C_{S}) is a predetermined offset value.

A relationship of the weight value W_{CL} of the achromatic detection range C_{CL} to the weight coefficients W_{D1}, W_{D2}, and W_{D3} is as follows.

W_{CL}=K(C_{CL}, D₁)·W_{D1}+K(C_{CL}, D₂)·W_{D2}+K(C_{CL}, D₃)·W_{D3}+Of(C_{CL})

where the coefficient K(C_{CL}, Dᵢ) in the formula is a value determined by the similarity degree between the achromatic detection range C_{CL} and the illumination color of a group Dᵢ, and the coefficient Of(C_{CL}) is a predetermined offset value.

A relationship of the weight value W_{SH} of the achromatic detection range C_{SH} to the weight coefficients W_{D1}, W_{D2}, and W_{D3} is as follows.

W_{SH}=K(C_{SH}, D₁)·W_{D1}+K(C_{SH}, D₂)·W_{D2}+K(C_{SH}, D₃)·W_{D3}+Of(C_{SH})

where the coefficient K(C_{SH}, Dᵢ) in the formula is a value determined by the similarity degree between the achromatic detection range C_{SH} and the illumination color of a group Dᵢ, and the coefficient Of(C_{SH}) is a predetermined offset value.

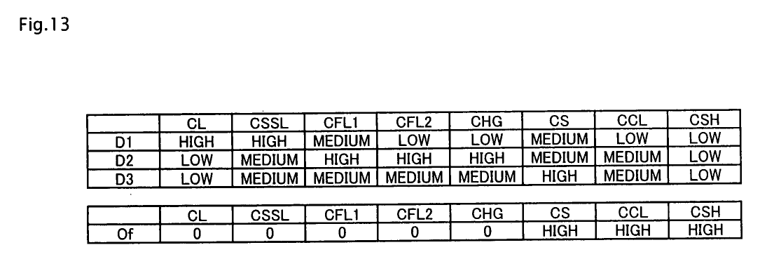

Note that magnitude correlations of the coefficients K and Of in each of the above formulas are as shown in FIG. 13, for example. In FIG. 13, “High” indicates a value equal to or close to +1, “Low” indicates a value equal to or close to −1, and “Medium” indicates a medium value between −1 and +1 (−0.5, +0.5, etc.).

Step S127: The CPU 29 divides the main image into a plurality of small regions.

Step S128: The CPU 29 calculates the chromaticity of each small region of the main image (average chromaticity in the region) and projects each of the small regions onto the chromaticity coordinates according to the chromaticity thereof. Further, the CPU 29 finds the small regions, projected into the achromatic detection ranges C_{L}, C_{SSL}, C_{FL1}, C_{FL2}, C_{HG}, C_{S}, C_{CL}, and C_{SH} among the small regions, and calculates the centroid position of the small regions on the chromaticity coordinates.

Note that, at this time, the number (frequency) of the small regions projected into the respective achromatic detection ranges C_{L}, C_{SSL}, C_{FL1}, C_{FL2}, C_{HG}, C_{S}, C_{CL}, and C_{SH} are multiplied by the weight values calculated in the step S126, W_{L}, W_{SSL}, W_{FL1}, W_{FL2}, W_{HG}, W_{S}, W_{CL}, and W_{SH} respectively. That is, the frequency of the small regions projected into the achromatic detection range C_{L} is multiplied by the weight value W_{L}, the frequency of the small regions projected into the achromatic detection range C_{SSL} is multiplied by the weight value W_{SSL}, the frequency of the small regions projected into the achromatic detection range C_{FL1} is multiplied by the weight value W_{FL1}, the frequency of the small regions projected into the achromatic detection range C_{FL2} is multiplied by the weight value W_{FL2}, the frequency of the small regions projected into the achromatic detection range C_{HG} is multiplied by the weight value W_{HG}, the frequency of the small regions projected into the achromatic detection range C_{S} is multiplied by the weight value W_{S}, the frequency of the small regions projected into the achromatic detection range C_{CL} is multiplied by the weight value W_{CL}, and the frequency of the small regions projected into the achromatic detection range C_{SH} is multiplied by the weight value W_{SH}. Here, considering the luminance of each small region, the number (frequency) of the small regions having high luminance may be counted on the larger side.

As described above, the CPU 29 of the present embodiment performs weighting on the frequency of each color existing in the main image according to the accuracy that a shooting scene belongs to the group D₁ (distance d₁), the accuracy that of the shooting scene belonging to the group D₂ (distance d₂), and the accuracy of the shooting scene belonging to the group D₃ (distance d₃), and thereby the probability that the illumination color is falsely estimated in the shooting is low even for shooting in which it is not sure to which group the shooting scene belongs.

Further, the CPU 29 of the present embodiment determines the weight value to be provided to the frequency of each color according to the similarity degree of the each color with the illumination colors of the groups D₁, D₂, and D₃, and thereby the illumination color in the shooting can be estimated in a high accuracy.

Still further, the CPU 29 of the present embodiment emphasizes the discrimination result (weight coefficient) for the group easy to discriminate in estimating the illumination color in shooting more than the discrimination result (weight coefficient) for the group difficult to discriminate. Thereby, the probability that the illumination color is falsely estimated is suppressed to be low.

### Other Embodiments

Note that, while the CPU 29 of the second embodiment uses the calculation formula for calculating the weight value for each of the achromatic detection ranges from the weight coefficients of the respective groups, a lookup table may be used. By using the lookup table, it is possible to increase a processing speed for estimating the illumination color after shooting.

Further, while either of the foregoing embodiments performs serially the first discrimination processing, the second discrimination processing, and the third discrimination processing, the processings may be performed in parallel.

Still further, while either of the foregoing embodiments assumes not to use a flash emitting device, emission intensity of a flash may be included in the vector components of the feature vector, considering a possibility of using the flash emitting device.

Yet still further, while either of the foregoing embodiments includes the focal distance and the subject distance of the shooting lens as shooting conditions in the vector components of the feature vector, another shooting condition such as the f-number of the shooting lens may be included.

Yet still further, while either of the foregoing embodiments includes the edge amount of a field as a subject condition in the vector components of the feature vector, another subject condition such as the contrast of a field may be included.

Yet still further, in either of the foregoing embodiments, the CPU 29 sets the number of divisions for the achromatic detection range to be eight and the number of divisions for the group to be four. However, another combination of numbers may be used as the number of divisions for the achromatic detection range and the number of divisions for the group.

Yet still further, either of the foregoing embodiments assumes that the SVM learning is performed preliminarily and the data of the discriminant planes and the like (S₁, S₂, S₃, Thₚₒₛ₁, Th_{neg1}, Thₚₒₛ₂, Th_{neg2}, Thₚₒₛ₃, and Th_{neg3}) can not be rewritten, but, when the electronic camera is provided with a manually-white-balance-adjusting function adjusting the white balance according to a kind of illumination indicated by a user, the SVM may perform the learning and updates the data each time the kind of the illumination is indicated. Note that the data is stored in a rewritable memory in this case.

Yet still further, while either of the foregoing embodiments repeats the discrimination processing of the shooting scene during the time when the release button is being half-pressed, the discrimination processing may be performed once immediately after the release button has been half-pressed. In this case, the discrimination result immediately after the release button has been half-pressed is retained during the time when the release button is being half-pressed.

Yet still further, while the monocular reflex type electronic camera performing the field observation and the main image acquisition with using different image sensors is described in either of the foregoing embodiments, the present invention can be applied to a compact type electronic camera performing the field observation and the main image acquisition with using a common image sensor.

Yet still further, while either of the embodiments assumes the normal-recording mode for a recording mode of the electronic camera, for the RAW-recording mode, the CPU 29 may generate attached information including the data obtained by the discrimination and store the attached information into the recording medium 32 together with the RAW-data of the main image. After that, in the development processing of the RAW-data, the CPU 29 may read the RAW-data from the recording medium 32 and execute the above described steps S110 to S115 (or S121 to S115).

Yet still further, while the electronic camera performs the calculation processing of the white balance adjusting value in either of the foregoing embodiments, a part of or the whole of the processing may be performed by a computer. In this case, a program necessary for the processing is installed in the computer. The install is performed via a recording medium such as a CD-ROM or the Internet.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A color photographing apparatus, comprising:
a discriminating unit calculating an accuracy of a shooting scene belonging to a specific group having a similar illumination color, based on a feature vector of said shooting scene and a discriminant criterion calculated preliminarily by supervised learning; and
a calculating unit calculating an adjusting value of white balance adjusting to be performed on an image shot in said shooting scene based on said calculated accuracy and said image.

2. The color photographing apparatus according to claim 1, wherein
said discriminating unit calculates an Euclidean distance between said feature vector and said discriminant criterion in a vector space as an index for said accuracy.

3. The color photographing apparatus according to claim 1, wherein said discriminating unit calculates said accuracy for each of a plurality of specific groups having different illumination colors.

4. The color photographing apparatus according to claim 3, wherein
said calculating unit calculates said adjusting value based on a frequency of each color existing in said image and performs weighting for the frequency of said each color according to the accuracy calculated for each of said plurality of specific groups.

5. The color photographing apparatus according to claim 4, wherein
said calculating unit determines a weight value to be provided to the frequency of said each color according to the accuracy calculated for each of said plurality of specific groups and a similarity degree between the illumination color of the specific group and said each color.

6. The color photographing apparatus according to claim 3, wherein
said calculating unit emphasizes, among said plurality of specific groups, the accuracy calculated for a specific group which is easy to discriminate from other groups than the accuracy calculated for a specific group which is difficult to discriminate from other groups.

7. The color photographing apparatus according to claim 3, wherein
said plurality of specific groups is any three among
a group having an illumination color which would belong to a chromaticity range of a low-color-temperature illumination, a group having the illumination color which would belong to the chromaticity range of a fluorescent lamp or a mercury lamp, a group having the illumination color which would belong to the chromaticity range of a fluorescent lamp with good color rendering properties or natural sunlight, and a group having the illumination color which would belong to the chromaticity range of a shadow area or cloudy weather.

8. The color photographing apparatus according to claim 1, wherein
said discriminating unit performs calculation of said accuracy during a period before shooting and
said calculating unit performs calculation of said adjusting value immediately after shooting.

9. The color photographing apparatus according to claim 1, wherein
said discriminating unit is a support vector machine.

10. The color photographing apparatus according to claim 1, further comprising
an adjusting unit performing the white balance adjusting on said image using the adjusting value calculated by said calculating unit.
